(19) United States
(12) Patent Application Publication
(10) Pub. No.: US 2026/0092504 A1
(43) Pub. Date: Apr. 2, 2026

(54) FLEXIBLE COUPLING ARRANGEMENT FOR DIRECTIONAL DRILLING SYSTEM

(71) Applicant: Imdex Technologies Pty Ltd, Balcatta (AU)

(72) Inventor: Per Jonny Nutudal, Heimdal (NO)

(21) Appl. No.: 19/066,472

(22) Filed: Feb. 28, 2025

(30) Foreign Application Priority Data
Oct. 1, 2024 (AU) 2024224009

(51) Int. Cl. E21B 17/046; E21B 7/04; E21B 19/18

(52) U.S. Cl. CPC E21B 17/0465; E21B 7/04; E21B 19/18

(57) ABSTRACT

A flexible coupling arrangement for use in a directional drilling system. The flexible coupling arrangement comprising a coupler body arranged to couple and transmit torque from a rear driveshaft to a front driveshaft. A plurality of keyways in one of the coupler body or the front driveshaft configurable to align and pair with a plurality of grooves in the other one of the coupler body or the front driveshaft. Each pairing of keyway and groove having a key member positioned therebetween so as to prevent relative rotation between the front driveshaft and the coupler body. Each of the plurality of grooves and/or each of the plurality of keyways tapers away from a generally longitudinally central region of each of the plurality of grooves so as to accommodate flexion of the front driveshaft relative to the coupler body.

### FIELD OF INVENTION

The present disclosure relates to a flexible coupling arrangement for use in a directional drilling system such as a directional core drilling system, full face directional drilling system and/or a rotary steerable system (RSS).

### BACKGROUND

The exploration process in many industries including the areas of mining, oil and gas often require drilling holes which intentionally deviate from a straight hole. This allows drillers to avoid problematic geological features or areas and/or improve the surveying of one or more zones of interest.

Each drill pipe is generally coupled to each successive drill pipe, drill bit, or other bottom hole assembly (BHA) by way of a threaded connection. Accordingly, current solutions for drilling deviated holes use a method of bending driveshafts within the drill string into a double-curved or s-shaped deformation to make a drill steer in a specific direction and make a curved borehole (i.e. one or more dog-legs). Depending on the curve radius (also referred to as a dog-leg) desired to achieve within the borehole, the offset distance of the eccentric bearing is altered to change the drill-bit angle (as seen in FIG. 1).

Generally speaking, the driveshaft at the front end of the drill string is supported by a spherical bearing and the adjusted eccentric bearing creates a curve on the driveshaft resulting in an angle change on the drill bit. At the opposite end, the driveshaft connects to a centralized component leading to the s-shaped deformation and stress conditions. Solutions which may improve the ability to deviate from a straight whole, reduce stresses within a drill string and improve maintenance are desirable.

Any references to methods, apparatus or documents of the prior art are not to be taken as constituting any evidence or admission that they formed, or form part of the common general knowledge.

### SUMMARY OF INVENTION

In an aspect, the invention provides a flexible coupling arrangement for use in a directional drilling system, the flexible coupling arrangement comprising:
a coupler body arranged to couple and transmit torque from a rear driveshaft to a front driveshaft;
a plurality of keyways in one of the coupler body or the front driveshaft configurable to align and pair with a plurality of grooves in the other one of the coupler body or the front driveshaft, each pairing of keyway and groove having a key member positioned therebetween so as to prevent relative rotation between the front driveshaft and the coupler body;
wherein each of the plurality of grooves and/or each of the plurality of keyways tapers away from a generally longitudinally central region of each of the plurality of grooves so as to accommodate flexion of the front driveshaft relative to the coupler body.

In an embodiment, the plurality of keyways are located about a radially inner or outer periphery of one of the coupler body or the front driveshaft.

In an embodiment, the plurality of grooves are located about a radially outer or inner periphery of the other one of the coupler body or the front driveshaft.

In an embodiment, the flexible coupling arrangement transmits torque by way of a splined or quasi-splined arrangement.

In an embodiment, each of the plurality of keyways comprise an opening less than the diameter of one of the plurality of key members so as to prevent the or each key member from moving radially towards a central axis of the coupler body.

In an embodiment, the flexible coupling arrangement comprises a retaining collar for retaining each of the plurality of key members within their respective keyways.

In an embodiment, the retaining collar is secured in the coupler body by way of a circlip.

In an embodiment, each of the plurality of grooves accommodate approximately up to 10 degrees of flexibility between the coupler body and the front driveshaft.

In an embodiment, each of the plurality of key members are separable from the coupler body.

In an embodiment, each of the plurality of key members is substantially cylindrical.

In an embodiment, the coupler body is configured for locating within a centraliser sub in a drill string.

In an embodiment, the plurality of grooves is disposed evenly about the radially outer surface of the front driveshaft.

In an embodiment, the plurality of keyways is disposed evenly about the radially inner periphery of the coupler body.

In an embodiment, the flexible coupling arrangement further comprises a thrust bearing, a washer or a concave seat element located between a radially extending surface of the coupler body and the front driveshaft.

In an embodiment, the thrust bearing or washer comprises a concave surface for accommodating the pivot of the front driveshaft.

In an embodiment, the directional drilling system is a directional core drilling system, a full face directional drilling system and/or a rotary steerable system (RSS).

In an aspect, there is provided a method of assembling a flexible coupling arrangement for connecting a rear driveshaft to a front driveshaft of a directional drilling system, the method comprising:
positioning a key member into each of a plurality of grooves on one of a coupler body or a front driveshaft;
locating the other one of the front driveshaft or the coupler body having a plurality of keyways in or over the other one of the front driveshaft or coupler body having the plurality of grooves each with an inserted key member to radially retain each of the key members therebetween the respective pairs of a groove and a keyway thereby rotationally coupling the coupler body and the front driveshaft relative to each other; and
securing the retaining collar to a radially extending end surface of the coupler body and/or the front driveshaft to retain each of the key members axially within their respective keyways;
wherein each of the plurality of grooves and/or each of the plurality of keyways taper from a generally central region of each of the plurality of grooves so as to accommodate pivoting of the respective key member in the groove.

In an embodiment, the method further comprises inserting a thrust bearing, washer or concave seat element into the aperture in the coupler body between the front driveshaft and a radially extending face of the coupler body.

In an embodiment, the method further comprises connecting a rear end of the coupler body to the rear driveshaft.

In an embodiment, the method further comprises connecting a front end of the front driveshaft to a drill bit assembly, bottom hole assembly or drill string.

In an aspect, there is provided a kit of parts for a flexible coupling arrangement for use in a directional drilling system, the kit comprising:
a coupler body couplable with a front driveshaft and a rear driveshaft, one of the coupler body or the front driveshaft having a plurality of keyways;
the other of the front driveshaft or the coupler body having a plurality of grooves wherein the grooves and/or the keyways taper from a generally longitudinally central region of each of the plurality of grooves so as to accommodate pivoting of the respective key member in the respective groove; and
a plurality of key members for insertion in between aligned pairs of a respective one of the plurality of keyways and a respective one of the plurality of grooves thereby rotationally coupling the coupler body and the front driveshaft.

In an embodiment, each of the plurality of key members are substantially cylindrical.

In an aspect, there is provided a coupling for allowing flexibility in the drill string at a joint in a drill string between drill rods.

The term “comprising” as used throughout this specification means “consisting at least in part of”. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF DRAWINGS

The embodiments described above by way of example only, and should not be considered limiting. Some variations are as follows.

Embodiments will now be described with reference to the following drawings, of which:

FIG. 1 shows an example traditional coupling within in a drill string for a directional drilling system.

FIG. 2 shows an example drill string for a directional drilling system.

FIG. 3 shows a cutaway of a flexible coupling arrangement according to an embodiment of the present invention.

FIG. 4 shows a side view of one of the plurality of key members located within one of the plurality of grooves of the front driveshaft.

FIG. 5 shows a cross section of the flexible coupling arrangement at the pivot point of the key members.

FIG. 6 is a side view of the front driveshaft and optional thrust bearing according to an embodiment of the present invention.

FIG. 7 is an exploded view of the flexible coupling arrangement of FIG. 3.

### DETAILED DESCRIPTION

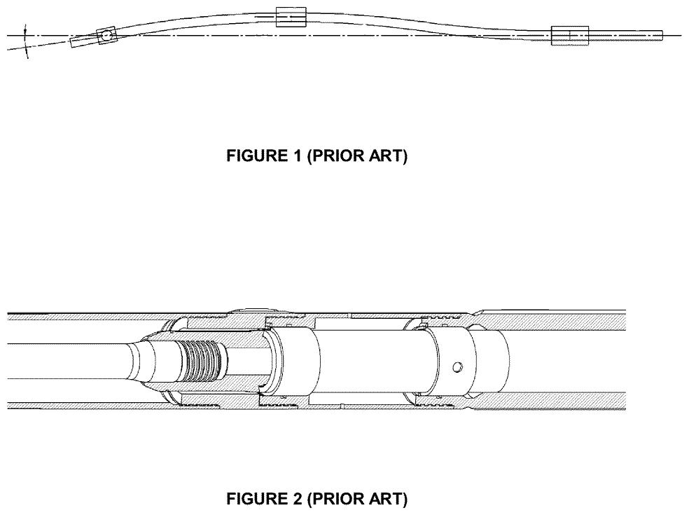

Referring to FIGS. 1 and 2 generally, there is illustrated an example of known solutions used within directional drilling. The solutions shown in FIGS. 1 and 2 utilise an arrangement whereby torque is transferred from the rear driveshaft to the front driveshaft via a threaded connection. Traditional solutions may further require one or more eccentric bearings and one or more spherical bearings which are used to support the drill string at necessary points along the drill string to accommodate a desired angle of deviation. In such solutions, the drill string is generally flexed within the elastic limit of the drill string allowing the drill string to deform without damaging the coupling with the front driveshaft 20 and the rear driveshaft 30 within the drill pipes 80A, 80B (collectively referred to as 80). Stresses at the joints and along the length of each of the drill string may lead to increased wear and tear, permanent damage or require specialty equipment to meet a desired deviation target.

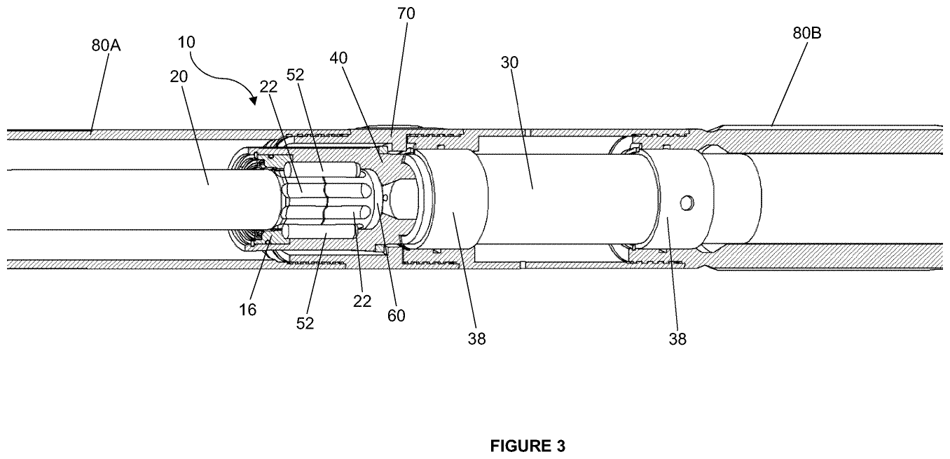

Referring to FIG. 3, there is provided a flexible coupling arrangement 10 according to a preferred embodiment of the present invention. The flexible coupling arrangement 10 may be used in a directional drilling system including, but not limited to, directional core drilling system, full face directional drilling system and/or a rotary steerable system (RSS). The flexible coupling arrangement 10 comprises a coupler body 40. The coupler body 40 is arranged to couple and transmit torque from a rear driveshaft 30 to a front driveshaft 20. The rear driveshaft 30 being operable connected or coupled with drive means, such as a motor.

The coupler body 40 comprises a plurality of keyways 42 (as seen in FIGS. 5 and 7). The plurality of keyways 42 are located about a radially inner periphery of the coupler body 40. The plurality of keyways 42 are open towards a central longitudinal axis of the coupler body 40. The plurality of keyways 42 are preferably integrally formed within the coupler body 40. Each of the plurality of keyways 42 designed for receiving a respective one of a plurality of key members 52. The coupler body 40 is configured to be fixed to the rear driveshaft 30. In the preferred embodiment, the rear driveshaft 30 is couplable with the coupler body 40 by way of a threaded engagement. In some alternative embodiments, the coupler body 40 may be an integrated or machined part of the rear driveshaft 30. The coupler body 40 may be machined into the rear driveshaft 30 or alternatively, fixedly or releasably coupled to the rear driveshaft 30. Alternative coupling means between the rear driveshaft 30 and the coupler body 40 may also be utilised.

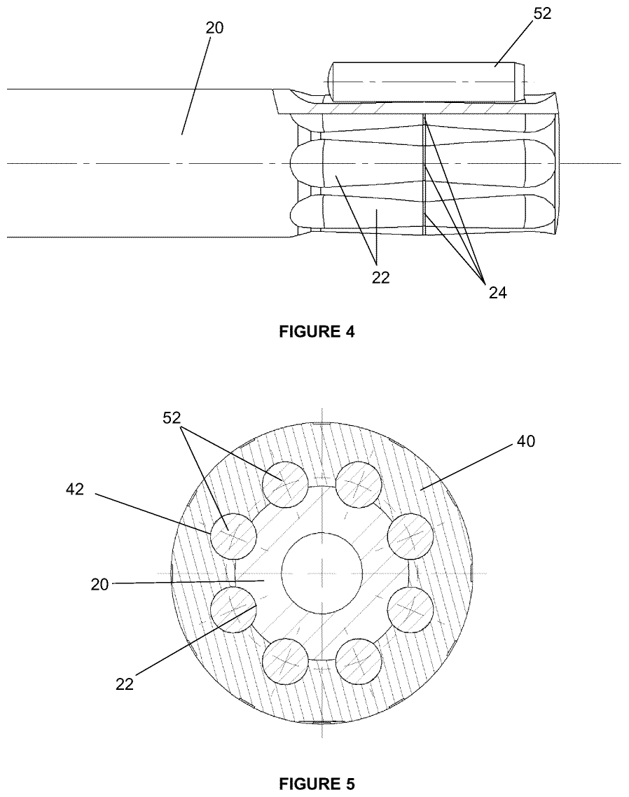

As seen in FIG. 4, the front driveshaft 20 is configured having a plurality of grooves 22 located on an outer periphery of the front driveshaft 20. The coupler body 40 is configured to receive an end of the front driveshaft 20 having the plurality of grooves 22. Each groove 22 tapers away from a generally longitudinally central region 24. In the preferred embodiment, the grooves 22 tapers radially towards a longitudinal axis of the front driveshaft 20 and/or tangentially to the longitudinal axis of the front driveshaft 20. The generally longitudinally central region 24 provides a pivot point for each of the key members 52 to pivot relative to the respective one of the grooves 22. The key members 52 pivot relative to the respective one of the grooves 22 when a longitudinal axis of the front driveshaft 20 moves out of alignment with a longitudinal axis of the coupler body 40. This allows flexion of the drill string by allowing the front driveshaft 20 to move out of alignment with the coupler body 40 before the drill string undergoes elastic deformation. Preferably, the tapering of the grooves 22 accommodate flexion of approximately 1°. After flexing exceeds approximately 1° the drill string may still undergo further elastic deformation to further meet the requirements for a drill program.

As would be appreciated by the person skilled in the art, in an alternative embodiment, the coupler body 40 may comprise the plurality of grooves 22 and the front driveshaft 20 comprise a plurality of keyways 42. In addition, the preferred embodiment as discussed in more detail below, illustrates the front driveshaft 20 being inserted into an aperture in the coupler body 40. However, in alternative embodiments, the front driveshaft 20 may be configured having an aperture for receiving the coupler body 40. As such, the plurality of keyways 42 may be located about a radially outer periphery or surface or an inner periphery or surface of one of the coupler body 40 or the front driveshaft 20. Further, the plurality of grooves 22 may be located about a radially outer periphery or surface or a radially inner periphery or surface of the other one of the coupler body 40 or the front driveshaft 20. Importantly, in whichever embodiment, the front driveshaft 20 and the coupler body 40 must be configurable to pair and align one of the plurality of keyways 42 with one of the plurality of grooves 22 so as to receive one of the plurality of key members 52.

As best illustrated in the cross section shown in FIG. 5, in the preferred embodiment, the plurality of grooves 22 are evenly disposed about a radially outer periphery at or near the end of the front driveshaft 20. The grooves 22 are preferably integrally formed within the outer surface of the end of the front driveshaft 20. In the preferred embodiment, the plurality of keyways 42 are evenly disposed about a radially inner periphery of the coupler body 40. The coupler body 40 preferably has a channel passing axially and longitudinally therethrough which defines an internal surface which the plurality of keyways 42 are integrally formed within. The front driveshaft 20 is configurable to align and pair the grooves 22 with respective keyways 42.

In addition, the preferred embodiment illustrates only the plurality of grooves 22 being tapered as described above. However, in other alternative embodiments, the plurality of keyways 42 may be tapered as described above. In further alternative embodiments, the plurality of keyways 42 and the plurality of grooves 22 may both be tapered either as a mirror image of each other or eccentrically for a specific implementation. In embodiments where both the plurality of grooves 20 and the plurality of keyways 42 have been tapered, each of the key members 52 will effectively be pivotably pinned in between the generally central regions of both the respective pairs of the keyway 42 and the groove 22.

The amount of taper and whether the taper is applied to one or both of the plurality of keyways 42 and the plurality of grooves 22 is subject to a number of factors including, but not limited to, the type of drill, the drilling application, the individual drill program and the requirements of each individual hole being drilled. The grooves 22 and the keyways 42 are tapered such that the flexible coupling arrangement 10 can provide a degree of flexion in the drill string. This allows the drill string to flex to a degree without putting additional bending stresses on the coupling itself. The flexible coupling arrangement 10 may be able to provide up to 10 degrees of flexion by tapering either the grooves 22, the keyways 42 or both. Higher angles of flexion may be less preferable due to additional wear and tear. The flexible coupling arrangement 10 may be provided in a number of set configurations which allow any number of degrees of flexion. For example, one of the flexible coupling arrangements 10 may be provided with the ability to flex 1 degree while another is provided with the ability to flex 10 degrees. Preferably, the coupler body 10 will be configured in 0.5-degree increments and will be able to be combined with a plurality of front driveshafts 20 to accommodate different desired levels of flexion.

Generally speaking, the flexible coupling arrangements 10 may be used where less flexion is required as this does not limit the ability to transmit torque from the rear driveshaft 30 to the front driveshaft 20. The flexible coupling arrangement 10 is designed, in part, to reduce stresses when the front driveshaft 20 is bent, e.g. by an eccentric bearing somewhere between the joint and a spherical bushing in the front of the front driveshaft 20. The required angle of the taper in the keyways 42 and/or the grooves 22 must be sufficient to accommodate maximum eccentricity (offset from center) of the eccentric bearing. A parameter affecting this is the proximity of the joint to the eccentric bearing. If the distance is short, the taper must be made to accommodate a larger angle than would be required if the distance is longer.

As seen in FIGS. 3 and 5, the front driveshaft 20 is inserted into the coupler body 40 such that the plurality of grooves 22 are located adjacent and align with a respective one of the plurality of keyways 42. Each pair of one of the plurality of grooves 22 with a respective one of the plurality of keyways 42 defines a void therebetween. The void provides a space for receiving and retaining one of the key members 52 therebetween. The plurality of key members 52 independently and/or collectively reduce and/or prevent relative rotation between the front driveshaft 20 and the coupler body 40. The plurality of key members 52 independently and/or collectively reduce and/or prevent axial movement of the front driveshaft 20 relative to the coupler body 40.

Generally speaking, the flexible coupling arrangement 10 operates similarly to a splined arrangement. In some instances, the person skilled in the art may define it as a splined arrangement. Hence, the flexible coupling arrangement 10 has been further defined as a quasi-splined arrangement. Each of the plurality of keyways 42 comprise an opening through the internal surface of the coupler body 40. The opening is preferably less than the diameter of one of the key members 52 such that each keyway 42 is suitable for retaining a key member within and preventing the respective one of the key members 52 from moving to or towards the longitudinal axis of the coupler body.

In the preferred embodiment, the key members 52 are separable from the coupler body 40 and the front driveshaft 20 to allow for maintenance and/or replacement due to wear and tear. Furthermore, in the preferred embodiment the key members 52 are substantially cylindrical. The key members 52 being cylindrical allows the key members 52 freedom to rotate which may assist in wear and tear being evenly distributed thereby increasing the lifespan of each of the key members 52. However, the key members may take on any number of shapes including, but not limited to, rectangular, triangular, ovoidal, etc. In the broadest scope of the invention there should be no limitation placed on the shape of the key members 52. In alternative embodiments, the key members 52 may be integrally formed within the coupler body 40 or the front driveshaft 20.

In some embodiments, the openings in the keyways 42 may be equal the diameter of a respective one of the key members 52. When installed, each of the key members 52 protrudes, at least in part, radially from the respective one of keyways 42 inwardly towards the longitudinal axis of the coupler body 40. Preferably, the key members 52 protrude sufficiently to abut the generally longitudinal central region 24 of the respective grooves 22. In some embodiments, the key members 52 may need only protrude sufficiently to retain the front driveshaft 20 within the coupler body 40.

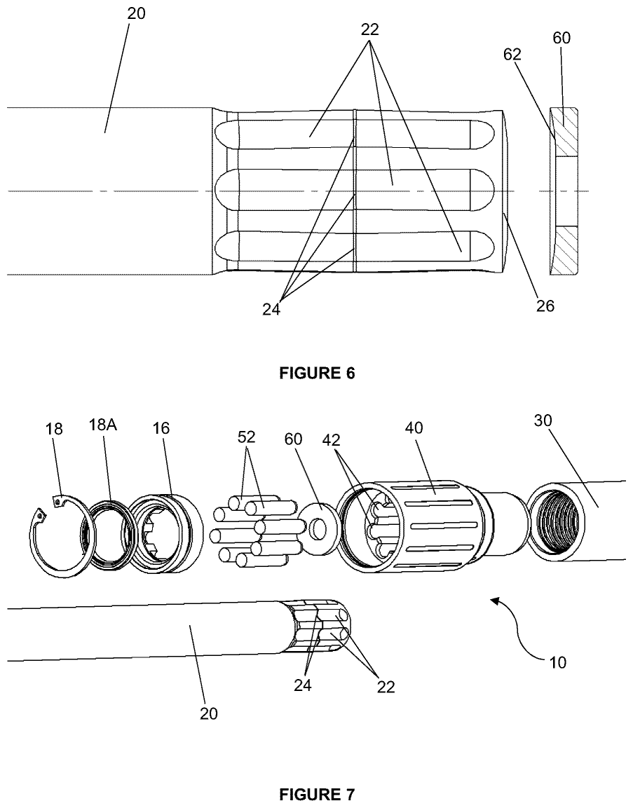

The flexible coupling arrangement 10 may optionally further comprise a thrust bearing 60 or washer as seen in FIGS. 6 and 7. The thrust bearing 60 preferably comprises a concave face 62 which conforms at least partially to the profile of the end face 26 of the front driveshaft 20. The thrust bearing 60 is located within the coupler body 40. The thrust bearing 60 is positioned to seat against a radially extending surface of the coupler body 40 such that the end face 26 of the front driveshaft 20 abuts the concave face 62 of the thrust bearing 60. The concave face 62 accommodates the pivoting of the front driveshaft 20 relative to the coupler body 40.

As seen in FIGS. 3 and 7, the flexible coupling arrangement preferably comprises a retaining collar 16. The retaining collar 16 is positioned inside or adjacent to the coupler body 40 to assist in preventing the front driveshaft 20 and/or the key members 52 from being removed from the respective keyways 42. The retaining collar 16 may have one or more seals or “O-rings” to assist in locating the retaining collar 16 within the coupler body 40 and/or preventing the ingress of fluid, dirt and/or debris into the coupler body 40. The seals and/or “O-rings” are preferably placed around a radial surface of the retaining collar 16. As such, when the retaining collar 16 is installed, the seals and/or “O-rings” are positioned between the retaining collar 16 and the coupler body 40 or the front driveshaft 20. The retaining collar 16 may be located and retained in place by way of a circlip 18 and one or more spacer or packer elements 18A. The spacer/packer elements 18A assist in ensuring a snug fit of the retaining collar 16 and the other essential and optional components within the coupler body 40. The circlip 18 may be compressed and inserted into an inner lip of the coupler body 40 and released to expand into a locking groove of the coupler body 40. In the preferred embodiment, the retaining collar 16 and circlip 18 retain the key members 52 in their respective keyways 42.

In alternative embodiments, the retaining collar 16 may be coupled to the flexible coupling arrangement 10 using other means known in the art. For example, the retaining collar 16 may have a threaded profile on the internal or external surface for locating adjacent to the coupler body 40 and/or the front driveshaft 20 so as to retain the key members 52 within their respective keyways 42. Accordingly, the retaining collar 16 may be coupled to the coupler body 40 and/or the front driveshaft 20 by threaded engagement. Notwithstanding the use of a threaded arrangement, the retaining collar 16 may be further located utilising circlips, grub screws or other means known in the art.

The flexible coupling arrangement 10 may further comprise a thrust bearing 60, a washer or other concave seat element. In embodiments where the optional thrust bearing 60 is utilised, the circlip 18 and retaining collar 16 will be located within the coupler body 40 to prevent, at least in part, excessive rattle of the thrust bearing 60. The thrust bearing 60, the washer or other concave seat element may assist with accommodating the pivoting of the end of the front driveshaft 20 during flexion. This may also prevent wear on the coupler body 40 and is more easily maintained and replaceable.

The coupler body 40 is configured for locating within a centraliser sub 70 in the drill string as seen in FIG. 3. The centraliser sub 70 is configured to house the coupler body 40. The centraliser sub 70 is adapted for connecting to the drill pipe 80B up hole and the drill pipe 80A downhole. The drill pipe 80 may form part of the directional drilling assembly, bottom hole assembly or similar. The drill pipe 80 isolates and shields the front driveshaft 20 and the rear driveshaft 30. The rear driveshaft 30 may be mounted on one or more slide bearings 38 (as seen in FIG. 3) allowing freedom to rotate and axial motion of the rear driveshaft 30 within the drill pipe 80.

The flexible coupling arrangement 10 is intended for use in a directional drilling system. Directional drilling systems include, but are not limited to, a directional core drilling system, a full face directional drilling system and/or a rotary steerable system (RSS). The flexible coupling arrangement 10 may have further applications whereby flexion in a torque transferring arrangement is utilised and/or threaded couplings are less suitable or entirely unsuitable.

The method of assembling the flexible coupling arrangement 10 will now be described with reference to the Figures generally.

The present invention provides a method of assembling a flexible coupling arrangement 10. The flexible coupling arrangement 10 being used for connecting a rear driveshaft 30 to a front driveshaft 20. Each of the plurality of key members 52 are inserted into a respective one of the grooves 22 of the front driveshaft 20. The end of the front driveshaft 20 having the plurality of grooves 22 with the key members 52 is inserted into the coupler body 40 while the key members 52 are located in each of the plurality of grooves 22 of the front driveshaft 20. The front driveshaft 20 will continue to be inserted until the grooves 22 of the front driveshaft 20 are adjacent and with a respective on of the keyways 42. This may be determined by the size of the thrust bearing 60 (if present). If a thrust bearing 60 is utilised, the thrust bearing 60 will be inserted into the coupler body 40. The thrust bearing 60 will be inserted into an end or aperture of the coupler body 40 until it abuts a radially extending face within the coupler body 40. The concave surface of the thrust bearing 60 is arranged to face axially towards the front driveshaft 20. Accordingly, in some embodiments, the front driveshaft 20 may be inserted until the end of the front driveshaft 20 abuts the thrust bearing 60 located within the coupler body 40.

Once the front driveshaft 20 and key members 52 within the grooves 22 of the front driveshaft 20 are positioned within the coupler body 40, the retaining collar 16 is slid down the front driveshaft 20 to abut the key members 52 within their respective keyways 42. Finally, the circlip 18 is compressed to be inserted into the coupler body 40 until adjacent to the locking groove within the inner lip of the coupler body 40. Once in position, the circlip 18 is allowed to expand into the locking groove within the inner lip of the coupler body 40. The circlip 18 will prevent the retaining collar 16 from being removed from the coupler body 40. If necessary, a user may insert one or more spacer/packer elements 18A between the retaining collar 16 and the circlip 18 to ensure a snug or tight fit.

In some embodiments, the protrusion of key members 52 from the respective keyways 42 may require the simultaneous insertion of the key members 52 and the front driveshaft 20 into the plurality of keyways 42. The locking of the key members 52 into their respective keyways 42 by way of the retaining collar 16 and circlip 18 reduces and/or eliminates axial movement of the front driveshaft 20 relative to the coupler body 40.

As best seen in FIG. 3, the flexible coupling arrangement 10 is housed within the centraliser sub 70 and/or the drill pipe 80. The assembly of the flexible coupling arrangement 10 may be done in stages. For example, the coupler body 40 may first be coupled to the rear driveshaft 40 and then the centraliser sub 70 coupled to the drill pipe 80B. Subsequently, the front driveshaft 20 having key members 52 in their respective grooves 22 may be inserted into the keyways 42 of the coupler body 40. The retaining collar 16, circlip 18 and any necessary spacer/packer elements 18A be installed to lock the key members 52 into place thereby locking the front driveshaft 20 relative to the coupler body 40. Finally, the drill pipe 80A covering the front driveshaft 20 is coupled to the centraliser sub 70. This is one of a number of ways in which the flexible coupling arrangement may be installed. Alternative methods may be employed subject to limitations relating to equipment and/or spatial limitations such as being in underground mines etc.

The coupler body 40 may be installed inside the centraliser sub 70 or inserted after assembly of the flexible coupling arrangement 10. The coupler body 40 may then be coupled with the rear driveshaft 30. Finally, the drill pipe 80B may be connected to the centraliser sub 70 having the flexible coupling arrangement 30 therein. The front driveshaft 20 may be further connected to a drill bit assembly, bottom hole assembly or drill string.

Given alternative embodiments may be provided where the coupler body 40 is inserted into the front driveshaft 20, the method of assembly will follow a similar nature as described above. The key feature being the locating of the key members 52 within the plurality of grooves 22 and then inserted into the keyways 42 until seated therebetween. Following insertion, the retaining collar 16 will be secured in place to prevent axial movement of the key members 52 from their respective keyways 42.

The flexible coupling arrangement 10 is intended to be used either with a new drill string or retrofitted into an existing drill string system. Accordingly, the flexible coupling arrangement 10 may be provided in a kit. The kit may be provided in isolation or in conjunction with several drill pipes 80. The present invention includes a kit of parts for a flexible coupling arrangement 10. The kit comprises a coupler body 40 couplable with a front driveshaft 20 and a rear driveshaft 30. The kit further comprises a coupler body 40 further comprises a plurality of keyways 42. A plurality of key members 52 for insertion into respective keyways 42. The kit further comprises a front driveshaft 20. The front driveshaft 20 having a plurality of grooves 22. The plurality of grooves 22 located about a radially outward surface of the front driveshaft 20. In the preferred embodiment, the plurality of grooves 22 are uniformly disposed about the radially outward surface of the front driveshaft 20. Each of the plurality of grooves 22 tapers from a generally longitudinally central region 24 of each of the plurality of grooves 22 so as to accommodate pivoting of the respective key member 52 in the respective groove 22.

As mentioned above, in the preferred embodiment, the plurality of key members 52 are substantially cylindrical. The ends of each of the plurality of key members 52 may also be rounded off to be smooth. The kit may further comprise a thrust bearing 60, washer or other concave seat member. The kit may further comprise one or more spacer/packer elements 18A.

The present invention provides several benefits and advantages over known solutions in the art. When drilling operations are halted due to a mechanical failure, the lost time when recognising, diagnosing and fixing or deploying a solution can be time-consuming and costly.

The flexible coupling arrangement 10 may reduce the stress in the front driveshaft 20, the rear driveshaft 30 and/or the coupling between the front driveshaft 20 and the rear driveshaft 30. As a result, the front flexible coupling arrangement 10 experiences less fatigue wear. The flexible coupling arrangement 10 may have increased strength in the coupling (when compared with traditional threaded connections) from utilising a splined or quasi-splined arrangement to transfer torque from the rear driveshaft 30 to the front driveshaft 20. In addition, the flexible coupling arrangement 10 removes axial tightening resulting from the high torque by using the splined or quasi-splined arrangement. Embodiments which incorporate the spherical thrust washer 60 may allow a high thrust force through the spline coupling. The flexible coupling arrangement 10 may allow for a reduced drill string length and/or improve the ability to navigate while drilling due to improved flexion in the drill string. Additional benefits not expressly discussed may nevertheless be present.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A flexible coupling arrangement for use in a directional drilling system, the flexible coupling arrangement comprising:
a coupler body arranged to couple and transmit torque from a rear driveshaft to a front driveshaft;
a plurality of keyways in one of the coupler body or the front driveshaft configurable to align and pair with a plurality of grooves in the other one of the coupler body or the front driveshaft, each pairing of keyway and groove having a key member positioned therebetween so as to prevent relative rotation between the front driveshaft and the coupler body;
wherein each of the plurality of grooves and/or each of the plurality of keyways tapers away from a generally longitudinally central region of each of the plurality of grooves so as to accommodate flexion of the front driveshaft relative to the coupler body.

2. The flexible coupling arrangement according to claim 1, wherein the plurality of keyways are located about a radially inner or outer periphery of one of the coupler body or the front driveshaft.

3. The flexible coupling arrangement according to claim 2, wherein the plurality of grooves are located about a radially outer or inner periphery of the other one of the coupler body or the front driveshaft.

4. The flexible coupling arrangement according to claim 1, wherein the flexible coupling arrangement transmits torque by way of a splined or quasi-splined arrangement.

5. The flexible coupling arrangement according to claim 1, wherein each of the plurality of keyways comprise an opening less than the diameter of one of the plurality of key members so as to prevent the or each key member from moving radially towards a central axis of the coupler body.

6. The flexible coupling arrangement according to claim 1, wherein comprises a retaining collar for retaining each of the plurality of key members within their respective keyways.

7. The flexible coupling arrangement according to claim 4, wherein the retaining collar is secured in the coupler body by way of a circlip.

8. The flexible coupling arrangement according to claim 1, wherein each of the plurality of grooves accommodate approximately up to 10 degrees of flexibility between the coupler body and the front driveshaft.

9. The flexible coupling arrangement according to claim 1, wherein each of the plurality of key members are separable from the coupler body.

10. The flexible coupling arrangement according to claim 1, wherein each of the plurality of key members are substantially cylindrical.

11. The flexible coupling arrangement according to claim 1, wherein the coupler body is configured for locating within a centraliser sub in a drill string.

12. The flexible coupling arrangement according to claim 1, wherein the plurality of grooves is disposed evenly about the radially outer surface of the front driveshaft and wherein the plurality of keyways is disposed evenly about the radially inner periphery of the coupler body.

13. The flexible coupling arrangement according to claim 1, wherein the flexible coupling arrangement further comprises a thrust bearing, a washer or concave seat element located between a radially extending surface of the coupler body and the front driveshaft.

14. The flexible coupling arrangement according to claim 12, wherein the thrust bearing or washer comprises a concave surface for accommodating the pivot of the front driveshaft.

15. The flexible coupling arrangement according to claim 1, wherein the directional drilling system is a directional core drilling system, a full face directional drilling system and/or a rotary steerable system (RSS).

16. A method of assembling a flexible coupling arrangement for connecting a rear driveshaft to a front driveshaft of a directional drilling system, the method comprising:
positioning a key member into each of a plurality of grooves on one of a coupler body or a front driveshaft;
locating the other one of the front driveshaft or the coupler body having a plurality of keyways in or over the other one of the front driveshaft or coupler body having the plurality of grooves each with an inserted key member to radially retain each of the key members therebetween the respective pairs of a groove and a keyway thereby rotationally coupling the coupler body and the front driveshaft relative to each other; and
securing the retaining collar to a radially extending end surface of the coupler body and/or the front driveshaft to retain each of the key members axially within their respective keyways;
wherein each of the plurality of grooves and/or each of the plurality of keyways taper from a generally central region of each of the plurality of grooves so as to accommodate pivoting of the respective key member in the groove.

17. The method according to claim 16, the method further comprising inserting a thrust bearing or washer into the aperture in the coupler body between the front driveshaft and a radially extending face of the coupler body.

18. The method according to claim 16, the method further comprising connecting a rear end of the coupler body to the rear driveshaft.

19. The method according to claim 16, the method further comprising connecting a front end of the front driveshaft to a drill bit assembly, bottom hole assembly or drill string.

20. A kit of parts for a flexible coupling arrangement for use in a directional drilling system, the kit comprising:
a coupler body couplable with a front driveshaft and a rear driveshaft, one of the coupler body or the front driveshaft having a plurality of keyways;
the other of the front driveshaft or the coupler body having a plurality of grooves wherein the grooves and/or the keyways taper from a generally longitudinally central region of each of the plurality of grooves so as to accommodate pivoting of the respective key member in the respective groove; and
a plurality of key members for insertion in between aligned pairs of a respective one of the plurality of keyways and a respective one of the plurality of grooves thereby rotationally coupling the coupler body and the front driveshaft.
